(19) United States
(12) Patent Application Publication
(10) Pub. No.: US 2013/0103563 A1
(43) Pub. Date: Apr. 25, 2013

(54) Anonymous Price and Progressive Display Execution System

(71) Applicant: William Francis Walsh, Basking Ridge, NJ (US)

(72) Inventor: William Francis Walsh, Basking Ridge, NJ (US)

(21) Appl. No.: 13/567,269

(22) Filed: Aug. 6, 2012

Related U.S. Application Data
(60) Provisional application No. 61/574,600, filed on Aug. 5, 2011.

(51) Int. Cl. G06Q 40/04

(52) U.S. Cl. CPC G06Q 40/04
USPC 705/37

(57) ABSTRACT

A method and system that allows for the progressive disclosure of information related the potential execution of product by establishing an anonymous alias and registering an interest in a proposed transaction based upon information that is both constructed by the alias and combined with information that is maintained and linked within a central authority whereby all such or certain information within the central facility can be disclosed at the appropriate time as the warranted by the situation.

This application is related to the provisional patent number 61/574600 filed Aug. 5, 2011.

### BACKGROUND OF THE INVENTION

1. Field of the Invention

The present invention relates to a system for the sale and or purchase of a single financial package that may include securities or legal agreements defining payout formulas containing such securities or other such measurable index or reference statistic and a technical management facility that facilitates the execution of financial arrangements or securities offered through an alias by an entity or entities such that the obligations contained therein are either directly or indirectly purchased by another entity or entities. The preferred embodiment of the invention relates to an electronic execution management facility that aggregates, reports, and analyzes the performance of the package of assets/liabilities and facilitates the electronic communication of such information from an alias to a number of aliases such that a subset of the information on each alias and financial package will be linked and made available to the other aliases at discrete points either automatically by the central facility or controlled automatically or manually by each entity. The same management facility will provide the ability for the aliases to progressively disclose and access such information in order to link and determine the suitability of certain combinations of aliases, package, and entity characteristics to buy or sell certain alias, package, and entity characteristics with another or others. It is notable that certain characteristics may or may not be altered by the facility or by the controlling entity and disclosed again at defined points within the disclosure process.

2. Description of the Prior Art

While transparency in financial markets is desirable in general, some important financial markets would not be well-served with greater transparency. The nature of the OTC (over the counter) derivatives markets dictates that information leakage will adversely affect the functioning and the very existence of the marketplace. This is because OTC derivative transactions are usually used to the hedge large exposures by institutions and any public knowledge of such exposures open institutions to predatory trading practices in related securities in order to profit from the knowledge of such exposures. As such, these markets are built upon intermediaries who preserve anonymity and use care and discretion to disclose transaction information in order to arrange for firms to transact directly with each other to minimize the leakage of information to the broader market associated with the transaction.

The OTC markets have traditionally been organized around one or more dealers who make markets by providing bid and offer quotes to market participants. The quotes and the negotiation of execution prices are generally conducted over the telephone, although the process may be enhanced through the use of electronic bulletin boards by the dealers for posting their quotes. The process of negotiating by phone, whether end-user-to-dealer or dealer-to-dealer is known as bilateral trading because only the two market participants directly observe the quotes or execution. Pure voice brokerage provides multiple market participants with the ability to obtain, evaluate and execute against multiple bids or offers on the other side of the market.

OTC derivatives markets also make use of electronic brokering platforms. These electronic brokering platforms are analogous to the electronic trading platforms used by exchanges where bid and offer quotes are displayed. The ultimate goal is to create a multilateral trading environment. However, at this time, electronic platforms are primarily used by brokers and dealers and much less by end-users. These systems allow dealers to post brokered interests, facilitating pre-trade price discovery. Furthermore, these systems are not click-and-trade and traders still need to telephone to generate a trade. Finally, live tradable prices are not feasible for large segments of the market because either too much or too little information is available in order to determine the appropriate price. At the time of this writing, the market is evolving toward multi-broker electronic platforms where participants can send RFQs (requests for quotes) to multiple dealers. However, not all RFQs are seen by all participants. The RFQ is the basis for generating interest, and responding dealers will send a price taking into account the size of the trade, the counter party's credit rating and other such information. The client initiating the RFQ can then click and trade within a set time with any responding dealer.

The current shortcoming of the RFQ capabilities is its inability to offer the correct balance between complete multi-lateral anonymity amongst participants while retaining key information and only making needed information involving historic and linked counter-party data available in a manner which discloses relevant information to the appropriate parties at the appropriate time.

### SUMMARY OF THE INVENTION

The present invention is a method and system that produces a decentralized multi-lateral electronic execution facility that is regulated by a central facility through which anonymous participants can anonymously define and direct trading interest to other anonymous participants such that an orderly process will electronically disclose and display certain information to certain entities through user regulated aliases at various steps throughout the negotiation and response process. This allows counter-parties to manage the level of information exposed to a closed community on a case by case basis and reduce information leakage while discovering genuine transaction opportunities.

This is achieved through the use of multiple user aliases whose relevant information is tied to its firms' legally regulated information and disclosed in a systematic manner depending on the stage of the negotiation, the product being negotiated, and the intentions of the parties. The multiple aliases of participants will be both manually adjusted anytime by the participants and algorithmically managed by the system preferences. The multiple aliases will each be linked to a user account and a single set of firm level information made available both on a firm level and on an alias level, depending on the rules of the market place for that particular product segment.

Such end user controlled but centrally managed capabilities result in an orderly process to anonymously discover interest levels by directing interest form one or a number of aliases to one or a number of aliases (available by firm categories, alias history, ect) and offer the interested parties the opportunity to protect relevant information as closely or disseminated as widely as the situation requires. Participants can each approach the market based upon their competitive advantage by maintaining a ‘brand’ alias or by randomizing its alias or resetting its alias after each trade or all of the above. It is envisaged that each situation will require its own unique approach and the management of multiple aliases will become a central tenant of interaction within this marketplace.

Thus the central tenant of the invention is the manipulation of multiple aliases whose characteristics are tied to a single centrally managed and verified source of linked firm-level and transaction information that is progressively displayed to participants in stages during the negotiation process. There can be numerous negotiation processes that have well defined disclosure rules across a number of product categories. One or a number of negotiation processes can be used as determined by the marketplace. The market may, for example, allow each alias to request a different negotiation process for the same trading intention.

### DETAILED DESCRIPTION OF THE PREFERRED EMBODIMENTS

Systems and methods which, fulfill the above-mentioned needs and provide other beneficial features in accordance with the present invention are described below with reference to the figures. Those skilled in the art will readily appreciate that the description given herein with respect to the figures is for explanatory purposes only and is not intended in any way to limit the scope of the invention. In addition, common reference numbers are used throughout the figures to represent common elements.

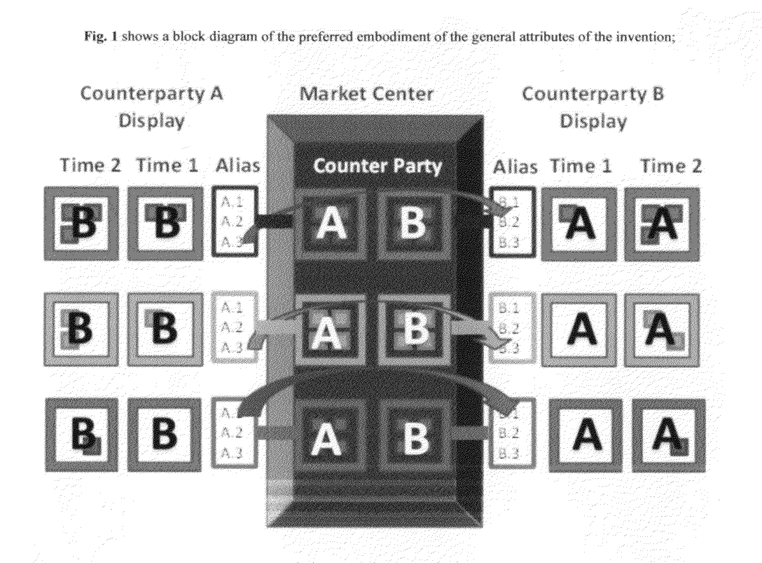

Referring now to the FIGURE, FIG. 1 shows a system block diagram of a preferred embodiment of the present invention. The product called Anonymous Price and Progressive Display Execution System is produced as follows. The figure illustrates a two counterparty scenario describing the multiple alias relationships between the two parties. While two parties are illustrated in order to detail the multiple alias and information relationships that may result in an execution based upon the combination of information disclosed between two parties, the preferred embodiment of the present invention is a system that manages the relationships of multiple aliases and combinations of information across n number of parties. As such, FIG. 1 simplifies the system for illustration purposes only. The two parties, Party A and Party B, are represented opposite each other and separated by the central facility where the complete set of information on all information is processed stored and disseminated in accordance with the structure of the facility. FIG. 1. also represents three scenarios of alias and information sets of disclosures across the two parties. Each scenario is depicted by a color code, blue, orange and red. For each scenario the figure depicts a selected alias initiating contact through its linked entity at the central facility to another entity at the central facility linked to and outside alias. As such party A will disclose a subset of alias, order, party, performance and other information to be displayed to party B depicted in the box labeled A at time 1. In response, the selected alias will disclosed on behalf of Party B its chosen subset of alias, order, party, performance and other such subset information to Party A depicted in the box labeled B within the counterparty A display at time 1. Progressively, party A will disclosed another subset of information in the box labeled A within the party B display. In response, party B will disclose a progressive set of information within the box labeled B within the party A display. A second scenarios depicted with orange illustrates the initiation of a similar process of information exchange between the same parties but with different aliases linked to the same of different subsets of information exchanged. A third or any number of aliases can initiate a similar process depicted within FIG. 1. While FIG. 1. depicts two time series, Time 1 and Time 2, any number of time series can be controlled either by the alias/entity or the central facility. The information can also be updated, disclosed, and displayed by either the alias/entity of the central facility.

Those skilled in the art will readily appreciate that the description given herein with respect to the figures is for explanatory purposes only and is not intended in any way to limit the scope of the invention.

We claim:

1. A method for executing a single financial product that combines financial elements into a single financial element and links it to an alias, an entity and other information through a single computer-based management facility comprising the steps of:
selecting at least one characteristic of a proposed transaction
selecting at least one alias to link to the proposed transaction
establishing a link between the alias and other information tied to the alias
establishing communication with at least another alias
and disclosing at least one element of the information to the additional alias
responding with a disclosure of at least one element of the information from the additional alias
establishing a mechanism whereby both aliases agreeing to transact based upon the disclosures

2. An apparatus for executing a single financial product that combines financial elements into a single financial element and links it to an alias, an entity and other information through a single computer-based management facility comprising the steps of:
means for choosing at least one characteristic of a proposed transaction
means for choosing at least one alias to link to the proposed transaction
means for choosing a link between the alias and other information tied to the alias
means for communication with at least another alias
and disclosing at least one element of the information to the additional alias
means for responding with a disclosure of at least one element of the information from the additional alias
means for establishing a mechanism whereby both aliases agreeing to transact based upon the disclosures

3. In a computerized system for executing a single financial product that combines financial elements into a single financial element and links it to an alias, an entity and other information through a single computer-based management facility a method comprising the steps of:
method for choosing at least one characteristic of a proposed transaction
method for choosing at least one alias to link to the proposed transaction
method for choosing a link between the alias and other information tied to the alias
method for communication with at least another alias
and disclosing at least one element of the information to the additional alias
method for responding with a disclosure of at least one element of the information from the additional alias
method for establishing a mechanism whereby both aliases agreeing to transact based upon the disclosures
